(19) United States
(12) Patent Application Publication
(10) Pub. No.: US 2023/0334109 A1
(43) Pub. Date: Oct. 19, 2023

(54) Method For Significantly Improving The Online Access Speed Of Matlab Web App

(71) Applicant: Yangtze university, Jingzhou (CN)

(72) Inventors: XIANG-E SUN, Jingzhou (CN); JIAN WEI, Jingzhou (CN); LIN HU, Jingzhou (CN); MEIHUA LIU, Jingzhou (CN)

(21) Appl. No.: 17/978,588

(22) Filed: Nov. 1, 2022

(30) Foreign Application Priority Data
Apr. 13, 2022 (CN) 202210384789.X

(51) Int. Cl. G06F 16/957; H04L 67/02

(52) U.S. Cl. CPC G06F 16/957; H04L 67/02

(57) ABSTRACT

A method for significantly improving the online access speed of MATLAB Web App, comprising: 1) determining the type of the Web App to determine whether it requires file conversion: 2) using Frontend technology to create the application layout of the MATLAB Web App; 3) using a high-level programming language Python to write a Backend program, finding a MATLAB Engine API for Python in a MATLAB installation directory, and importing it into a library file of Python; 4) installing and configuring a Nginx server; (5) installing and configuring a NAT tool; 6) after web App completes the response, the user's browser receives the numerical data results from the Backend and other results from the Nginx side respectively. It solves the problem of slow loading of the MATLAB application on the Web side, uses the Frontend technology to design the application, and combines the Python Web technology to build a deployment platform.

### CROSS-REFERENCE TO RELATED APPLICATIONS

This application claims priority to Chinese Patent Application No. 202210384789.X, filed on Apr. 13, 2022, the contents of which are herein incorporated by reference in their entireties.

### TECHNICAL FIELD

The present application relates to the technical field of public communication networks, in particular to a method for significantly improving the online access speed of MATLAB Web App.

### BACKGROUND

As an excellent programming and digital computing tool, the difficulty in using it to run out of the MATLAB environment has always been the biggest pain point in the minds of engineers. To this end, MATLAB launched MATLAB Web App technology to host and share MATLAB applications to the cloud as interactive web applications. Usually, Web App design of MATLAB is completed by GUIDE or App Designer, and deployed to the cloud through the MATLAB Web App Server tool. Users only need to enter the unique URL (Uniform Resource Locator) pointing to the homepage of the MATLAB Web App Server or the application itself on the browser side, and can access and run without any configuration without the MATLAB environment. GUIDE is an older application design platform, and App Designer is its updated and iterative product. GUI programs can be converted into Web Apps that are suitable for App Designer to run through a migration tool. At present, the development and deployment of MATLAB applications are mostly based on this, such as the design of online classrooms for mathematical experiments, and the development of virtual simulation test systems. At the same time, there are other methods such as calling based on a dynamic link library and embedding GUI web pages based on Java technology. However, these methods have some disadvantages, such as slow loading speed, browsers that do not support the chrome 49 kernel, and the deployment tools having single functions and bugs.

In trying to resolve these issues, we discovered that slow app loading was caused by the original design architecture of the MATLAB App Designer, and at the same time, there are frequent useless verification links on the page loading side, which greatly slows down the loading speed of the application. We studied its working principle and proposed methods such as browser preloading and using a fixed session id, but these methods are not permanent, and due to the security policy of MATLAB software, programmers cannot perform black-box optimization through three parties. We also found that the reason why some parts of the MATLAB web app did not support the Chrome 49 kernel browser is because of the limitation of the Windows XP system, some protocols do not have corresponding technical response requirements after the system stops operation and maintenance. Finally, the deployment tool has a single function and has bugs, such as some bugs when deploying multi-version web applications. After the MATLAB Runtime path is configured, only the first path in the configuration list can be run, and the server needs to be reset in the terminal to repair. The single function of the deployment tool cannot be customized and developed is also a major reason that hinders its development.

The prior art has the following three problems:

1) The deployed app loads slowly on the page side. After testing, on Intel processors, the loading time of applications is generally more than 15 s, and on AMD processing, the loading time of applications is generally more than 2 s;

2) The application is incompatible with some browser versions. For example, in the browser with the chrome 49 kernel, some components may not be fully loaded and the function cannot be realized;

3) There are application-level bugs in the official MATLAB Web App Server deployment tool. For example, when deploying a multi-version web application, after configuring the MATLAB Runtime path, it can only match the first path of the running configuration list, and you need to reset the server on the terminal to fix it. At the same time, the deployment tool has a single function, and the black box strategy is difficult to optimize, which brings much trouble to the later application deployment.

### SUMMARY

The object of the present application is to provide a method for significantly improving the online access speed of the MATLAB Web App, using Frontend technology to design applications and combining it with Python Web technology to build a deployment platform. This method modularizes the design and deployment of the application. The Frontend is responsible for the page performance and fluency of the application, and the Backend is responsible for the multi-concurrency and high performance of the application. The two modules perform their functions and complement each other, which significantly improves the development quality of the application and the user experience. At the same time, compared with the limitations of MATLAB's application components and the single function of shared tools, the customized service greatly improves the playability with the application and stimulates the enthusiasm of users. It is suitable for all teaching platforms and enterprise R&D fields with MATLAB as the main tool.

To achieve the above objective, the present application provides the following technical solutions: a method for significantly improving the online access speed of the MATLAB Web App, comprising the following steps:

(1) Preliminary preparation, determining the type of the Web App to determine whether it requires file conversion:

(2) using Frontend technology to create the application layout of the MATLAB Web App:

(3) on a hosted application, using a high-level programming language Python to write a Backend program, finding a MATLAB Engine API for Python in a MATLAB installation directory, and importing it into a library file of Python;

(4) installing and configuring a Nginx server, using the Nginx server to deploy Frontend static resources, and pages that the user accesses on a browser side;

(5) installing and configuring a NAT tool so that its monitoring address and port are consistent with configuration information of the Nginx server to achieve intranet penetration of the Nginx server;

(6) after the web app completes a response, the user's browser receives the numerical data results from the Backend and other results from the Nginx side.

Furthermore, the preliminary preparation of step (1) includes two possibilities, namely, if the App is created by GUIDE, no processing is required; if the App is created by App Designer, it needs to be exported as an m-file.

Furthermore, the create the application layout of the MATLAB Web App in step 2 is realized by mounting Html on the Frontend framework Vue, and creating a RESTful API connected to the Backend.

Furthermore, in step (3), FastAPI is used as the asynchronous framework of the Backend program, and Uvicom is used as the ASGI server to build an application program interface. When the RESTful API requests of the Backend and Frontend complete the docking, respond and activate the relevant functions, the functions complete the call to the m file of the target application through the Python three-party package MATLAB engine, generate the result and directly feed the numerical data to the browser, w % bile other data such as pictures are sent to the Nginx server.

Compared with the prior art, the beneficial effects of the present application are as follows:

1) Solved the problem of slow loading of MATLAB applications on the web side. The application loading time of the traditional method is generally about 10 s, while the loading time of this method is less than 1 s;

2) Solved the problem that the application is incompatible with some browser versions. The traditional method is limited by system limitations, while this method has no requirements, as long as the browser protocol is supported;

3) Solved the limitation that the MATLAB Web App Server deployment tool has a single function and is difficult to optimize. Relying on Python's excellent third-party libraries and open-source code, customized development and deployment of applications can be achieved.

### BRIEF DESCRIPTION OF DRAWINGS

To more clearly illustrate the embodiments of the present application or the technical solutions in the prior art, the following briefly introduces the accompanying drawings that are required to be used in the description of the embodiments or the prior art. The drawings in the following description are some embodiments of the present application, and for those of ordinary skill in the art, other drawings can also be obtained from these drawings without creative effort. Similar elements or parts are generally identified by similar reference numerals throughout the drawings. In the drawings, each element or section is not necessarily drawn to the actual scale.

FIG. 1 is the schematic flow chart of the present application;

### DETAILED DESCRIPTION

In the description of this application, it should be noted that the orientation or positional relationship indicated by the terms “upper”, “lower”, “inner”, “outer”, “frontend”, “rear end”, “two ends”, “one end”, “the other end”, etc., is based on the orientation or positional relationship shown in the accompanying drawings, and is only for the convenience of describing the present application and simplifying the description. It is not indicated or implied that the indicated device or element must have a particular orientation, be constructed, and operate in a particular orientation, and therefore should not be construed as limiting the present application. Furthermore, the terms “first” and “second” are used for descriptive purposes only and should not be construed to indicate or imply relative importance.

In the description of the present application, it should be noted that, unless otherwise expressly specified and limited, the terms “installed”, “provided with”, “connected”, etc. should be understood in a broad sense, for example, “connected” may be a fixed connection, but it can also be a detachable connection or an integral connection; it can be a mechanical connection or an electrical connection; it can be a direct connection, or an indirect connection through an intermediate medium, or the internal communication between the two components. For those of ordinary skill in the art, the specific meanings of the above terms in the present application can be understood in specific situations.

The technical solutions in the embodiments of the present application will be clearly and completely described below about the accompanying drawings in the embodiments of the present application. The described embodiments are only a part of the embodiments of the present application, but not all of the embodiments. Based on the embodiments of the present application, all other embodiments obtained by those of ordinary skill in the art without creative efforts shall fall within the protection scope of the present application.

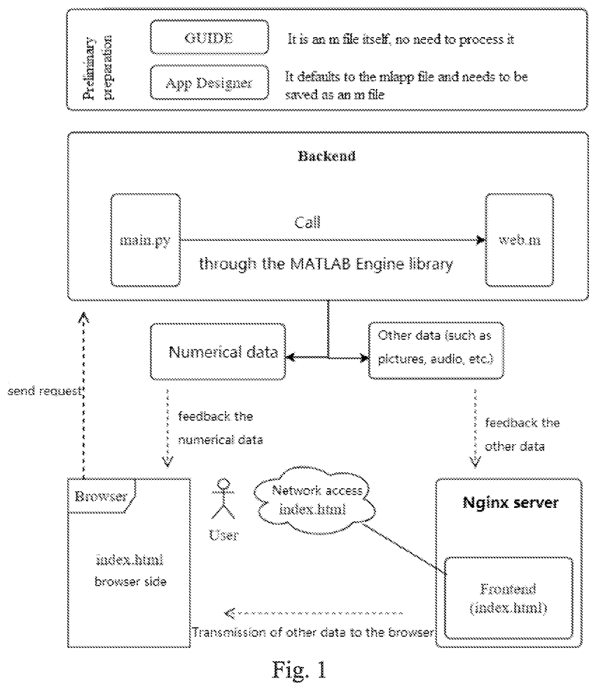

Referring to FIG. 1, the present application provides a technical solution: a method for significantly improving the online access speed of the MATLAB Web App, comprising the following steps:

(1) Preliminary preparation, determining the type of the Web App to determine whether it requires file conversion, if the App is created by GUIDE, no processing is required; if the App is created by App Designer, it needs to be exported as an m-file;

(2) using Frontend technology to create the application layout of the MATLAB Web App; for example, choose Semantic UI as the Frontend framework to write the application interface, and choose jQuery as the JavaScript library to write the application function. Here, the Frontend framework Vue is used to mount the Html, and create a RESTful API connected to the Backend;

(3) on a hosted application, using a high-level programming language Python to write a Backend program, finding a MATLAB Engine API for Python in a MATLAB installation directory, and importing it into a library file of Python, wherein FastAPI is used as an asynchronous framework for the Backend program, and Uvicorn is used as an ASGI server to build an application program interface. When the Backend and Frontend RESTful API requests are connected, the related functions are responded to and activated. The functions complete the m-m of the target application through the Python three-party package MATLAB engine. File calls, generate results and directly feed numerical data to the browser, while other data such as pictures are sent to the Nginx server;

(4) installing and configuring a Nginx server, using the Nginx server to deploy Frontend static resources, and pages that the user accesses on a browser side, including static resources such as html, js, css, and jpg, are derived from this; after the Frontend sends a request and gets the Backend response, it is also responsible for receiving other dynamic resources generated by the m script, such as pictures, etc.;

(5) installing and configuring a NAT tool so that its monitoring address and port are consistent with configuration information of the Nginx server to achieve intranet penetration of the Nginx server;

(6) after the web app completes a response, the user's browser receives the numerical data results from the Backend and other results from the Nginx side.

In summary, the present application uses Frontend technology to design applications and combines Python Web technology to build a deployment platform. This method modularizes the design and deployment of the application. The Frontend is responsible for the page performance and fluency of the application, and the Backend is responsible for the multi-concurrency and high performance of the application. The two modules perform their functions and complement each other, which significantly improves the development quality of the application and the user experience. At the same time, compared with the limitations of MATLAB's application components and the single function of shared tools, the customized service greatly improves the playability of the application and stimulates the enthusiasm of users. It is suitable for all teaching platforms and enterprise R&D fields with MATLAB as the main tool.

Although embodiments of the present application have been shown and described, it will be understood by those skilled in the art that various changes, modifications, and substitutions can be made in these embodiments without departing from the principle and spirit of the application and modifications. The scope of the present application is defined by the appended claims and their equivalents.

What is claimed is:

1. A method for significantly improving the online access speed of MATLAB Web App, comprising the following steps:
(1) Preliminary preparation, determining the type of the Web App to determine whether it requires file conversion;
(2) using Frontend technology to create the application layout of the MATLAB Web App;
(3) on a hosted application, using a high-level programming language Python to write a Backend program, finding a MATLAB Engine API for Python in a MATLAB installation directory, and importing it into a library file of Python;
(4) installing and configuring a Nginx server, using the Nginx server to deploy Frontend static resources, and pages that a user accesses on a browser side;
(5) installing and configuring a NAT tool so that its monitoring address and port are consistent with configuration information of the Nginx server, so as to achieve intranet penetration of the Nginx server;
(6) after the web App completes a response, the user's browser receives the numerical data results from the Backend and other results from the Nginx side respectively.

2. The method for significantly improving the online access speed of MATLAB Web App according to claim 1, wherein the preliminary preparation of the step (1) includes two possibilities, namely, if the App is created by GUIDE, no processing is required; if the App is created by App Designer, it needs to be exported as an m-file.

3. The method for significantly improving the online access speed of MATLAB Web App according to claim 1, wherein the create the application layout of the MATLAB Web App in step 2 is realized by mounting Html on the Frontend framework Vue, and creating a RESTful API that connects to the Backend.

4. The method for significantly improving the online access speed of MATLAB Web App according to claim 1, wherein in step (3), FastAPI is used as the asynchronous framework of the Backend program, and Uvicom is used as the ASGI server to build an application program interface, when the RESTful API requests of the Backend and Frontend complete the docking, respond and activate the relevant functions, the functions complete the call to the m file of the target application through the Python three-party package MATLAB engine, generate the result and directly feed the numerical data to the browser, while other data such as pictures are sent to the Nginx server.
